(19) United States
(12) Patent Application Publication
(10) Pub. No.: US 2016/0010247 A1
(43) Pub. Date: Jan. 14, 2016

(54) Three Dimensional Weave Fabric

(71) Applicant: Avery Dennison Retail Information Services, LLC, Mentor, OH (US)

(72) Inventor: Mathieu DE BACKER, Grottammare (IT)

(21) Appl. No.: 14/580,695

(22) Filed: Dec. 23, 2014

Related U.S. Application Data
(60) Provisional application No. 62/021,822, filed on Jul. 8, 2014.

(51) Int. Cl. D03D 25/00; B32B 5/02; D03D 3/00

(52) U.S. Cl. CPC D03D 25/005; D03D 3/00; B32B 5/024; D10B 2501/00; B32B 2437/00; B32B 2307/736

(57) ABSTRACT

A three dimensional weave fabric material is disclosed for use in producing garments and other items. The three dimensional weave fabric material comprises two layers of material, a face layer and back layer. The face layer and the back layer are then woven together via floating threads to create predetermined patterns or areas where the two layers are not woven together. These areas which are not woven together create tubes. Specifically, the weaving is controlled by a computer program that will weave or not weave the two layers together. Once the weaving is complete, the three dimensional weave fabric material is heat treated. The heat treating process shrinks the floating threads, causing manipulation of the tube. Specifically, the tube puffs or stands up more than if there was no heat treatment. Additionally, the tubes can be filled with fibers or other suitable materials to make the puffed areas more firm.

### CROSS-REFERENCE TO RELATED APPLICATION

The present application claims priority from U.S. Provisional Application No. 62/021,822 filed Jul. 8, 2014, which is incorporated by herein by reference in its entirety.

### BACKGROUND

The present invention relates generally to a woven tubular fabric created by novel weaving techniques. More particularly, the present disclosure relates to a three dimensional woven tubular fabric for garments and other items that provides a performance-enhancing stretch function.

Fabrics are typically made from corresponding raw materials and are constructed by weaving, knitting, plaiting or braiding. For example, felt fabrics are produced by the interlocking of fibers. Fabrics are primarily classified into woven fabrics, knitted fabrics, felt fabrics, plaited fabrics, non-woven fabrics, laminated fabrics and molded fabrics by standard production methods thereof.

In a narrow sense, woven fabrics refer to fabrics constructed by interlacing vertical warp threads with horizontal weft threads at right angles. Woven fabrics are the most widely used fabrics for under wears and outer wears. Knitted fabrics are constructed by making sets of threads into loops and combining the loops with one another in forward, backward, left and right directions. Knitted fabrics are rapidly produced by knitting and tend to be loose and elastic when being worn. Strands of fibers are interlocked by heat, moisture, pressure or striking to construct felt fabrics, thus eliminating the need for the use of threads. In plaited, braided and lace fabrics, individual threads are interlaced with sets of threads while sliding in any one direction to attain desired effects.

Non-woven fabrics are constructed by the application of adhesive materials, the attachment of fibers through chemical functions on the surface of the fibers, or the attachment of webs or sheets of thermoplastic fibers by heating. Laminated fabrics are constructed by laminating a foam to one or two woven fabrics to achieve improved flexibility and provide a cushiony feeling. The surface areas of molded fabrics are larger than those of the raw materials before extrusion. Molded articles (e.g., clothes) are cushiony, or are in the form of a pile or plate.

All of these fabrics are very wearable, match the functions of the human body, and are not readily deformed. Additionally, sewing and other fusion techniques are currently used to impart three dimensional shapes to fabrics. However, typically sewing and other fusion techniques currently used to impart three dimensional shapes to fabrics results in loss of the stretch function and other performance characteristics.

In an attempt to overcome the above problems, a three dimensional fabric has been created that comprises a face layer, and a back layer, woven together via floating threads. The face layer and the back layer are woven together to create predetermined patterns or areas where the two layers are not woven together. Thus, the floating threads comprise the threads connected to the stitched face layer and the stitched back layer in an alternating and repeating pattern. Specifically, the weaving is controlled by a computer program that will weave or not weave the two layers together. These areas which are not woven together create tubes. Once the weaving is complete, the three dimensional weave fabric material is heat treated. The heat treating process shrinks the floating threads, causing manipulation of the tube. Specifically, the tube puffs or stands up more than if there was no heat treatment. Thus, the novel weaving technique along with the heat treating process allows for an enhanced stretch function.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a three dimensional weave fabric material for use in producing garments and other items. The three dimensional weave fabric material comprises two layers of material, a face layer and a back layer. Typically, the face layer and the back layer are manufactured of synthetic material, or synthetic blends, such as polyester, but any other suitable material can be used as is known in the art. The face layer and the back layer are then woven together via floating threads. The face layer and the back layer are woven together to create predetermined patterns or areas where the two layers are not woven together. These areas which are not woven together create tubes. Specifically, the weaving is controlled by a computer program that will weave or not weave the two layers together.

In a preferred embodiment, once the weaving is complete, the three dimensional weave fabric material is heat treated. The heat treating process shrinks the floating threads, causing manipulation of the tube. Specifically, the tube puffs or stands up more than if there was no heat treatment. Additionally, the tubes can be filled with fibers or other suitable materials as is known in the art to make the puffed areas more firm, or to add texture or other similar features. Furthermore, the patterns and/or designs can be woven over the entire area of the garment, or just in limited areas on the garment, depending on the needs and wants of a user as well as manufacturing constraints. There can be a plurality of the same pattern and/or design, or a mixture of patterns and/or designs. The different size and/or shape of the patterns and/or designs are created by varying the size of the tube that is woven.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A illustrates a side sectional view of the three dimensional weave fabric material before heat treating in accordance with the disclosed architecture;

FIG. 1B illustrates a side section view of the three dimensional weave fabric material after heat treating in accordance with the disclosed architecture;

FIG. 2 illustrates a perspective view of the face layer and the back layer of the three dimensional weave fabric material in accordance with the disclosed architecture;

FIG. 3 illustrates a perspective view of the three dimensional weave fabric material in use as a woman's top in accordance with the disclosed architecture; and

FIG. 4 illustrates a perspective view of the three dimensional weave fabric material in use as a coat in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Sewing and other fusion techniques are currently used to impart three dimensional shapes to fabrics. However, typically sewing and other fusion techniques currently used to impart three dimensional shapes to fabrics results in loss of the stretch function and other performance characteristics. In an attempt to overcome the above problems, a three dimensional weave fabric material is disclosed for use in producing garments and other items. The three dimensional weave fabric material comprises two layers of material, a face layer and a back layer. The face layer and the back layer are then woven together via floating threads to create predetermined patterns or areas where the two layers are not woven together. These areas which are not woven together create tubes. Specifically, the weaving is controlled by a computer program that will weave or not weave the two layers together. Once the weaving is complete, the three dimensional weave fabric material is heat treated. The heat treating process shrinks the floating threads, causing manipulation of the tube. Specifically, the tube puffs or stands up more than if there was no heat treatment. Additionally, the tubes can be filled with fibers or other suitable materials to make the puffed areas more firm.

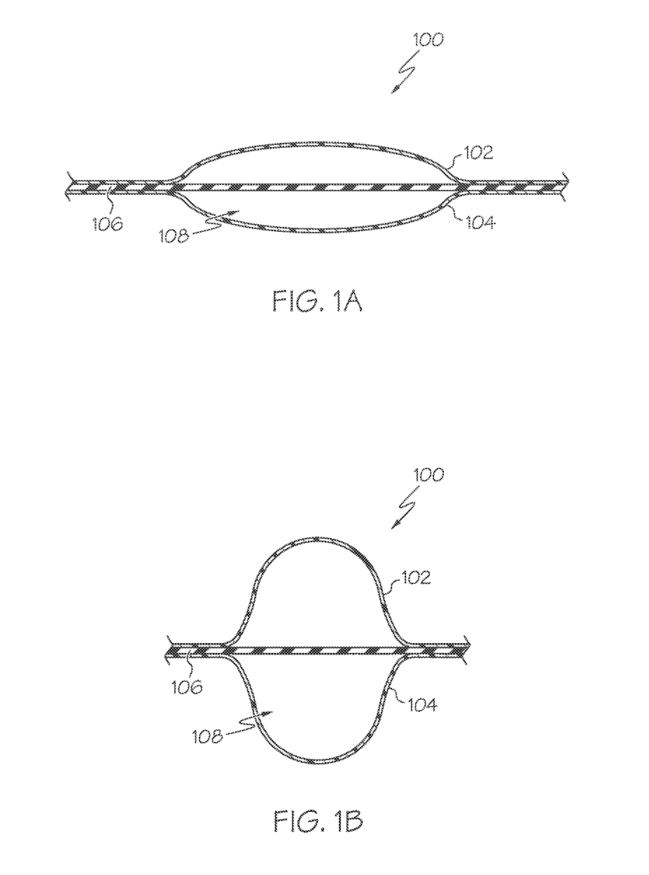

Referring initially to the drawings, FIGS. 1A-B and 2 illustrates a three dimensional weave fabric material 100 for use in producing garments and other items. Using the three dimensional weave fabric for producing garments is merely one possible example and the same fabric material may be used for any suitable application. Thus, although the term “fabric” is used throughout the present disclosure for exemplary purposes, the term “fabric” may be any single item or material, or a group of items or material.

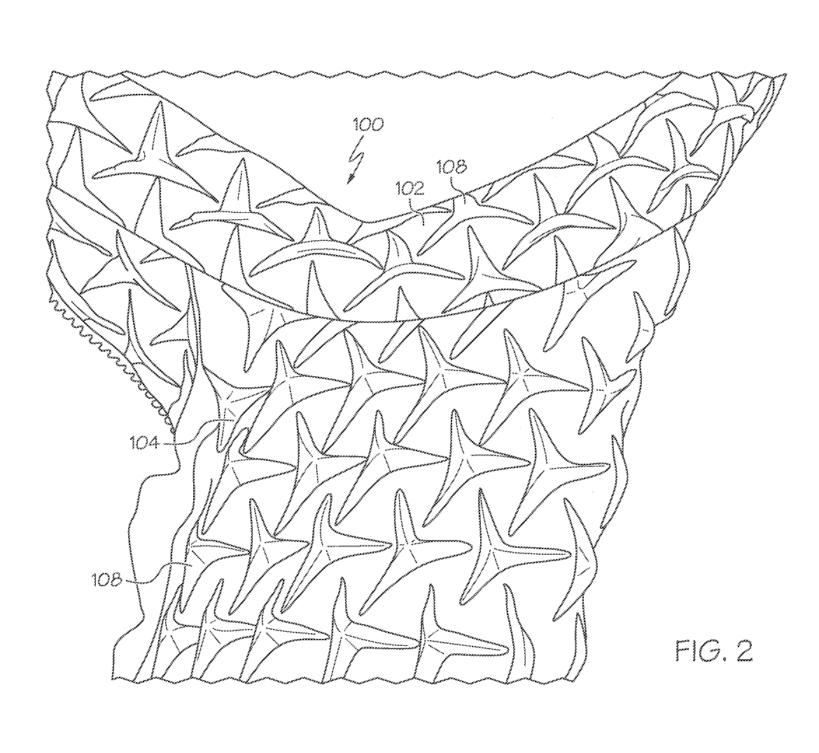

The three dimensional weave fabric material 100 comprises two layers of material, a face (or surface) layer 102 and a back layer 104 (as shown in FIG. 2). Typically, the face layer 102 and the back layer 104 are manufactured of synthetic material, or synthetic blends, such as polyester, but any other suitable material can be used as is known in the art without affecting the overall concept of the invention. The face layer 102 and the back layer 104 can be any suitable shape and size depending on the needs and wants of a user, as well as manufacturing constraints.

The face layer 102 and the back layer 104 are then woven together via threads 106. The threads 106 are preferably floating lycra threads but can be any other suitable material as is known in the art. For example, the threads 106 used may be monofilament yarns, multifilament yarns, spun yarns, etc. as desired, and these threads 106 can be made from artificial, natural or synthetic fibers depending on the user's needs or wants, and/or manufacturing constraints. The threads 106 may also be elastic or non-elastic yarn, or various combinations thereof. The type of threads 106 weaving the face layer 102 and the back layer 104 together throughout the body of the fabric material 100 and the number of yarns may be varied over wide ranges and will be primarily controlled by the desired end use for the fabric material 100. Typically, the threads 106 have a denier of from 70 to 900 and preferably between 70 and 500 denier.

The face layer 102 and the back layer 104 are woven together to create predetermined patterns or areas where the two layers 102 and 104 are not woven together. These areas which are not woven together create tubes (or gaps or pockets) 108. Specifically, the weaving is controlled by a computer program that will weave or not weave the two layers 102 and 104 together. Typically, the three dimensional fabric material 100 is produced on customized or purpose-built weaving machines, which incorporate a computer program to control the action of the threads 106.

Accordingly, the face layer 102 includes sequential unstitched surface portions and sequential stitched surface portions formed in an alternating and repeating pattern. For example, standard weaving will continue row after row. Then, when a tube or gap 108 is to be formed, the floating threads 106 are pushed into the two layers 102 and 104 (similar to a sewing machine), and then the weaving or sewing stops and resumes when enough space has been created for a gap or tube 108 to form. Specifically, the warp (or longitudinal threads of the weave) are split in order to create this gap or tube 108. This process is then repeated row after row until all the weaving is done.

Once the weaving is complete (as shown in FIG. 1A), the three dimensional weave fabric material 100 is then heat treated. The three dimensional weave fabric material 100 can be heat treated via any suitable heat treating process as is known in the art. The heat treating process shrinks the floating threads 106, causing manipulation of the tube or gap 108. Specifically, the tube or gap 108 puffs or stands up more than if there was no heat treatment (as shown in FIG. 18). Using synthetic material or synthetic blends for layers 102 and 104 allows the heat treating to shrink the synthetic material so as to create the puffed areas. The bigger surface area there is on the material, the more puffing can be created by the heat treatment. Typically, the puffed design extends into both layers of the three dimensional weave fabric material 100, creating the three dimensional design. However, the puffed design can be manipulated so that it is more exaggerated on one side or layer than the other side or layer. Additionally, the tubes or gaps 108 can be filled with fibers or other suitable materials as is known in the art to make the puffed areas more firm, or to add texture or other similar features.

Thus, the three dimensional weave fabric material 100 can be any suitable size, shape, and pattern as is known in the art without affecting the overall concept of the invention. One of ordinary skill in the art will appreciate that the size and/or shape of the face layer 102 and the back layer 104 as shown in FIGS. 1A and 1B is for illustrative purposes only and many other sizes and/or shapes of the layers 102 and 104 are well within the scope of the present disclosure. Although dimensions of the layers 102 and 104 (i.e., length, width, and height) are important design parameters for good performance, the layers 102 and 104 may be any size and/or shape that ensures an optimal stretch function and other performance characteristics.

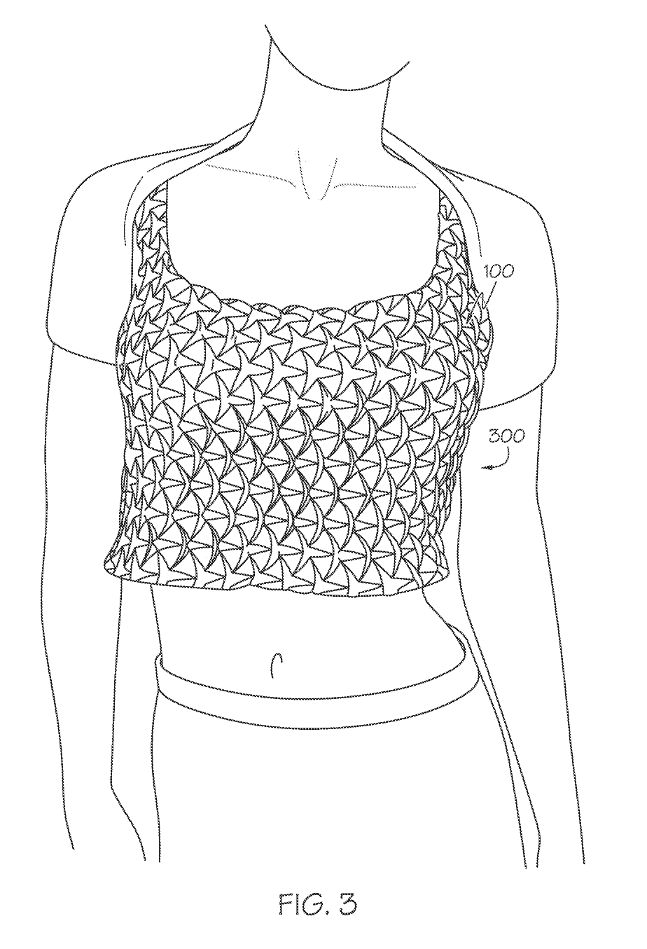

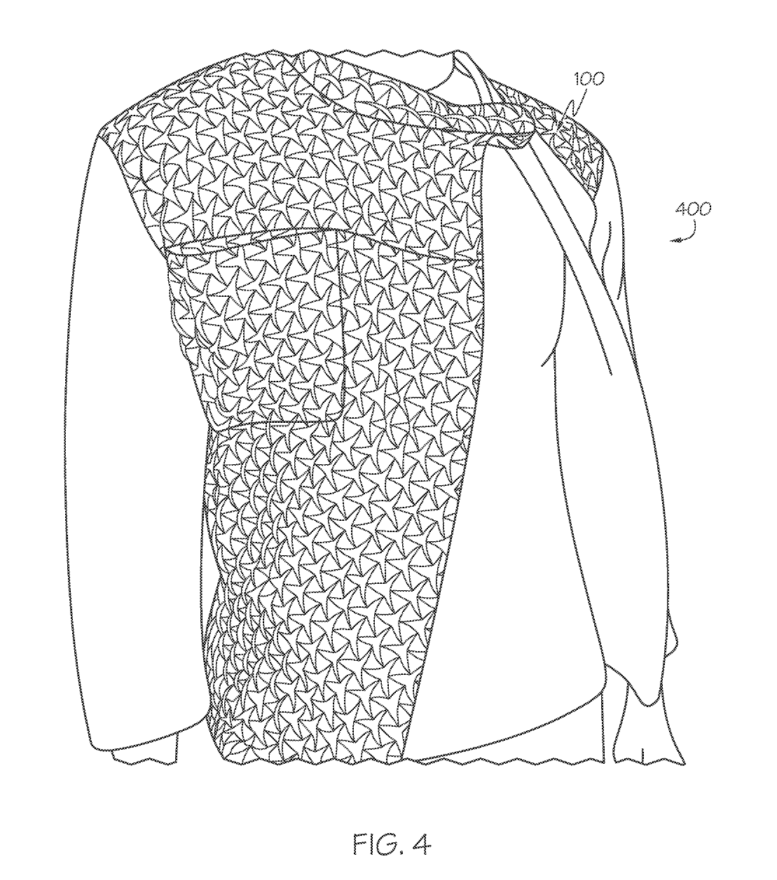

FIGS. 3-4 illustrate the three dimensional weave fabric material 100 in use. For example, FIG. 3 illustrates a woman's top 300 and FIG. 4 illustrates a jacket 400. The patterns and/or designs can be woven over the entire area of the garment, such as with the jacket 400 (shown in FIG. 4), or the woman's top 300 (shown in FIG. 3), or just in limited areas on the garment, depending on the needs and wants of a user as well as manufacturing constraints. Any pattern and/or design can be woven and the pattern and/or design can be of any shape or size. There can be a plurality of the same pattern and/or design, or a mixture of patterns and/or designs. Large patterns and/or designs can be utilized or small patterns and/or designs, or combinations of both large and small patterns and/or designs can be utilized. The different size and/or shape of the patterns and/or designs are created by varying the size of the tube or gap that is woven. Any size and/or shaped garment can be created with the pattern and/or design. Further, the patterns and/or designs can be used in woven labels, such as those labels found on the interior of a garment to help with branding.

FIG. 2, illustrates a first layer and second layer that are superimposed on one another and then by weaving certain sections of the layers together, and leaving other areas unsecured a pattern can be produced but subsequently heat treating the fabric such that the unwoven areas “puff” or rise up over the surface of the fabric to create tactile areas representing a particular pattern. It should be understood that any sort of pattern can be created, e.g. letters, numbers, geometric shapes, logos, brands, etc.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A three dimensional weave fabric material for garments, comprising:
a face layer; and
a back layer;
wherein the face layer is woven to the back layer via a plurality of threads to create a predetermined pattern; and
wherein the predetermined pattern comprises areas where the face layer and the back layer are not woven together.

2. The three dimensional weave fabric of claim 1, wherein the weaving is controlled by a computer program that will weave or not weave the face layer and the back layer together.

3. The three dimensional weave fabric of claim 1, wherein the areas where the face layer and the back layer are not woven together form tubes.

4. The three dimensional weave fabric of claim 3, wherein the tubes are manipulated a heat shrinking process.

5. The three dimensional weave fabric of claim 4, wherein the heat shrinking process shrinks the threads, causing the tubes to puff.

6. The three dimensional weave fabric of claim 5, wherein the tubes are filled with fibers to add texture.

7. The three dimensional weave fabric of claim 1, wherein the predetermined pattern is woven over an entire area of a garment.

8. The three dimensional weave fabric of claim 1, wherein the predetermined pattern is woven over a limited area of a garment.

9. The three dimensional weave fabric of claim 1, further comprising a mixture of more than one predetermined pattern on an entire area of a garment.

10. A three dimensional weave fabric material for garments, comprising:
a face layer; and
a back layer;
wherein the face layer is woven to the back layer via a plurality of floating threads to create a predetermined pattern; and
wherein the predetermined pattern comprises tubes that are areas where the face layer and the back layer are not woven together; and
wherein the tubes are manipulated via a heat shrinking process, causing the tubes to puff.

11. The three dimensional weave fabric of claim 10, wherein the weaving is controlled by a computer program that will weave or not weave the face layer and the back layer together.

12. The three dimensional weave fabric of claim 10, wherein the heat shrinking process shrinks the floating threads.

13. The three dimensional weave fabric of claim 10, wherein the puffed tubes can be manipulated such that the puffing is more exaggerated on the face layer.

14. The three dimensional weave fabric of claim 10, wherein the puffed tubes can be manipulated such that the puffing is more exaggerated on the back layer.

15. The three dimensional weave fabric of claim 10, wherein the predetermined pattern is woven over an entire area of a garment.

16. The three dimensional weave fabric of claim 10, wherein the predetermined pattern is woven over a limited area of a garment.

17. The three dimensional weave fabric of claim 10, wherein the tubes are filled with fibers to add texture.

18. A three dimensional weave fabric material for garments, comprising:
a face layer; and
a back layer;
wherein the face layer is woven to the back layer via a plurality of floating threads to create a predetermined pattern; and
wherein the predetermined pattern comprises tubes that are areas where the face layer and the back layer are not woven together; and
wherein the tubes are manipulated via a heat shrinking process to shrink the floating threads, causing the tubes to puff;
wherein the tubes are filled with fibers to add texture; and
wherein the weaving is controlled by a computer program that will weave or not weave the face layer and the back layer together.

19. The three dimensional weave fabric of claim 18, wherein the three dimensional weave fabric can be utilized in a woven label on an interior of a garment.

20. The three dimensional weave fabric of claim 18, wherein different sizes and shapes of patterns are created by varying size of the tubes that are woven.
